(19) United States
(12) Patent Application Publication
(10) Pub. No.: US 2009/0285401 A1
(43) Pub. Date: Nov. 19, 2009

(54) Providing Access To Content For a Device Using an Entitlement Control Message

(75) Inventors: Paul Moroney, Olivenhain, CA (US); Petr Peterka, San Diego, CA (US); Jiang Zhang, La Jolla, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/468,839

(22) Filed: May 19, 2009

Related U.S. Application Data
(60) Provisional application No. 61/054,373, filed on May 19, 2008.

(51) Int. Cl. H04L 9/06; G06Q 30/00; G06F 21/00; H04L 9/00

(52) U.S. Cl. 380/278; 705/51; 726/4; 713/150

(57) ABSTRACT

Providing access to content for devices is performed by providing multiple entitlement management messages (EMMs), each which including a service key, to the plurality of devices. Also, a same entitlement control message (ECM) is provided to the devices. The ECM includes an encrypted traffic key for decrypting content. Each of the devices derives an access key from the service key according to a business model level of access to the content for a user of the devices and uses the access key to decrypt the traffic key to access the content according to the business model level of access to the content for the each of the plurality of devices.

### PRIORITY

The present application is related to provisional U.S. Patent Application Ser. No. 61/054,373 (Attorney Docket No. BCS05115), titled “Improved Cipher Conditional Access System And Method”, filed May 19, 2008, which is incorporated by reference in its entirety.

### BACKGROUND

Key management systems typically employ messages known as entitlement control messages (ECMs) and entitlement management messages (EMMs) to control access to data streams. EMMs are control messages that convey access privileges and keys to subscriber devices. Unlike ECMs, which are embedded in transport multiplexes and are broadcast to multiple subscribers, EMMs are typically sent unicast-addressed to each subscriber device. That is, an EMM is usually specific to a particular subscriber.

For example, typically, each subscriber based on his or her access type receives an appropriate key in an EMM. For example, monthly subscribers to a channel receive an EMM which delivers a key valid for a full month, while subscribers to a smaller time portion of a channel or service would receive their EMM which delivers a less broad-in-time key, and pay per view subscribers would receive an EMM which delivers only the lowest level program specific key.

Conventionally, a separate ECM is employed for each service offering for different levels of subscribers based on their level of access. For example, there may be one ECM for monthly subscribers, and another for pay-per-view, or equivalently, a single much longer ECM. However, this wastes bandwidth and is often problematic in systems where bandwidth is an issue. Many conditional access systems, such as mobile TV systems, have very little bandwidth, yet still need to be sufficiently flexible to support a wide variety of access types.

### BRIEF DESCRIPTION OF THE DRAWINGS

Features of the present invention will become apparent to those skilled in the art from the following description with reference to the figures, in which:

FIG. 1 shows a simplified block diagram of a content distribution system including a wireless transmission network, according to an embodiment of the present invention;

FIG. 2 shows a diagram of an access key hierarchy in a content distribution system, according to an embodiment of the present invention;

FIG. 3 illustrates a flow diagram of a method for providing authorized access to content to multiple devices using one ECM, according to an embodiment of the present invention;

FIG. 4 illustrates a flowchart of a method for providing authorized access to content to multiple devices with different access types using one way key derivation processes, according to an embodiment of the present invention;

FIG. 5 shows a block diagram of a device that may represent any one of the user devices shown in FIG. 1, according to an embodiment of the present invention; and

FIG. 6 shows a block diagram of a computer system that may be used as a platform for a service provider, according to an embodiment of the present invention.

### DETAILED DESCRIPTION

For simplicity and illustrative purposes, the present invention is described by referring mainly to exemplary embodiments. In the following description, numerous specific details are set forth to provide a thorough understanding of the embodiments. However, it will be apparent to one of ordinary skill in the art that the present invention may be practiced without limitation to these specific details. In other instances, well known methods and structures have not been described in detail to avoid unnecessarily obscuring the description of the embodiments.

In an embodiment of the present invention, authorized access to content to a device is provided by providing the same entitlement control message (ECM) to multiple devices. An entitlement management message (EMM) delivering a service key is also provided to the multiple devices. The ECM includes a single encrypted traffic key for decrypting content at each of the multiple devices. Each of the multiple devices derives an access key from its EMM delivered service key and the ECM, according to a business model level of access to the content for a user of the device, and uses the access key to decrypt the traffic keys to access the content.

In an embodiment, a request for access to content is received from a first device and an EMM including a service key appropriate to the requested level of access as well as an ECM including an encrypted traffic key for decrypting content in the first device is provided. A request for access to content is received from a second device and an EMM including a service key appropriate to the requested level of access as well as the same ECM that is provided to the first device is provided for decrypting content in the second device.

In a conditional access system, each content stream is associated with a stream of ECMs that serves two basic functions: (1) to specify the access requirements for the associated content stream (i.e., what privileges are required for access for particular programs); and (2) to convey the information needed by subscriber devices to compute the cryptographic key(s), which are needed for content reception. ECMs are transmitted in-band alongside their associated content streams. Typically, in traditional CA systems, ECMs are cryptographically protected by a “monthly key”, which changes periodically, usually on a monthly basis. The monthly key is typically distributed by EMMs prior to or concurrently with the ECMs.

EMMs are control messages that convey access privileges and keys to subscriber devices. Unlike ECMs, which are embedded in transport multiplexes and are broadcast to multiple subscribers, EMMs are typically sent unicast-addressed to each subscriber device. That is, an EMM is specific to a particular subscriber. In a typical implementation, an EMM contains information about the monthly key, as well as information that allows a subscriber device to access an ECM, which is sent concurrently or later. In an embodiment of the present invention, EMMs also define the level of subscription for each subscriber. With reference to cable services, for example, a first EMM may allow access to HBO™, ESPN™, and CNN™. A second EMM may allow access to ESPN™, TNN™, and BET™, etc. A third EMM for a different subscriber may allow access to a 24-hour period for ESPN. A fourth EMM may allow access to a specific event (program) of TNN. These are examples of different services and different business model levels of access to the content for the services.

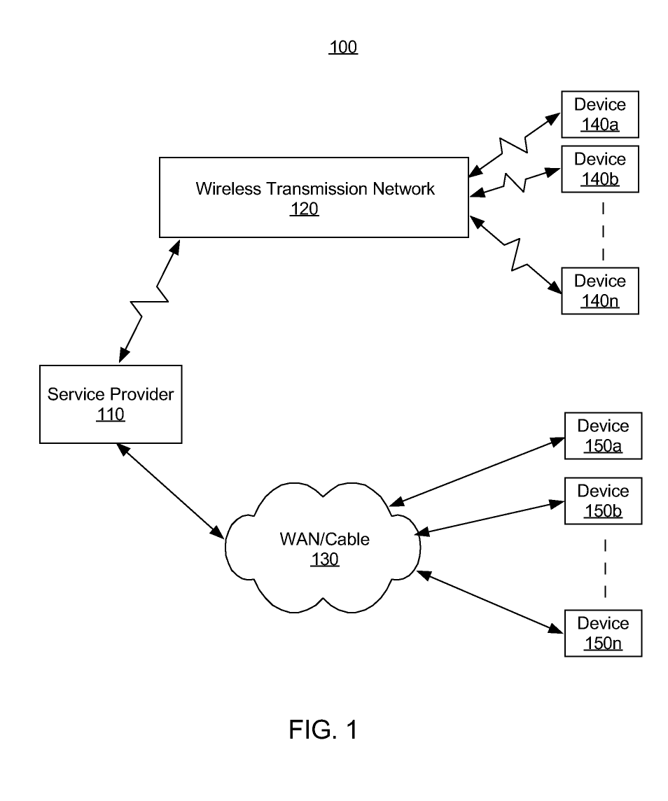

FIG. 1 illustrates a block diagram of a content distribution system 100 including a wireless transmission network 120, according to an embodiment of the present invention.

The system 100 includes a service provider 110, a wireless transmission network 120, such as a Wireless Wide Area Network (WWAN), WiMax, 3GPP, terrestrial or a satellite transmission network, and a landline transmission network 130, such as a Wide Area Network (WAN), DSL, fiber or a cable network. The system 100 also includes a plurality of devices 140a-140n and 150a-150n for users to receive content from the service provider 110 via the satellite transmission network 120 and via the landline transmission network 130, respectively. As referred herein, content provided to users includes any audio or video data or information, such as streamed audio services, streamed video services, streamed data services or files that are broadcast using a protocol such as File Delivery over Unidirectional Transport (FLUTE). As also referred herein, a user is an individual, a group of individuals, a company, a corporation, or any other entity that purchases, subscribes, or is authorized otherwise to receive access to one or more particular content services. Examples of users include but are not limited to Cable TV (CATV) subscribers, satellite TV subscribers, satellite radio subscribers, IPTV subscribers, and Pay-Per-View (PPV) purchasers of PPV events. As also referred herein, a PPV event is a particular content program for which a user is charged when or just before such content is accessed.

As further referred herein, a service provider is an individual, a group of individuals, a company, a corporation, or any other entity that distributes content to one or more users. Examples of service providers are CATV, satellite TV, satellite radio, wireless mobile service provider, and online music providers or companies. In turn, the service provider receives content from one or more content providers (not shown), such as film studios, record companies, television broadcasting networks, etc. It should be noted that a content provider is also operable as a service provider to directly provide its content to users in the same manner as shown for the service provider 110 in FIG. 1. As also referred herein, a device is that device used to access content provided by a service provider (or content provider), which content the user has authorization to access. Examples of devices include, but are not limited to set-top boxes (cable, satellite or IP STBs), CATV, satellite-TV, mobile handsets, and portable media players. It should be noted that a device is operable as either a stand-alone unit (e.g., an STB) or an integral part of a content-viewing device, such as a television with a built-in satellite or CATV receiver.

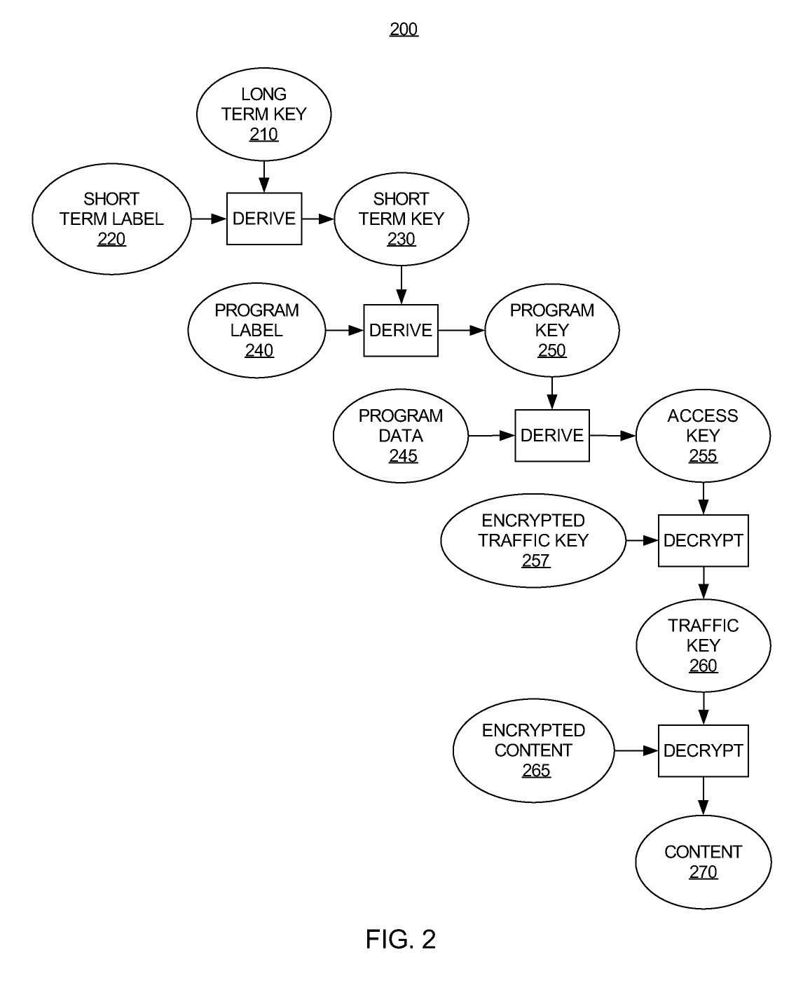

As referred herein, EMMs are the messages delivering service keys. An access key is derived from service keys, such as a long-term key, a short-term key and a program key. To use a single access key to encrypt a traffic key for all the services, according to an embodiment of the present invention, a hierarchy of keys is employed to minimize the length of the ECMs. FIG. 2 shows a diagram of a such a key hierarchy 200 in a content distribution system, according to an embodiment of the present invention.

Long-term key (LTK) 210 is a subscription service key that allows access to particular content for a specific length of time. Typically, the length of time is based on a monthly subscription schedule. However, the length of time may be longer than a month. The LTK 210 typically changes based on the designated billing cycle of every subscription (i.e., monthly) and is unique for each content service. A content service or service may be a single channel, and thus have its own long-term service key, or it may be a group of channels, such as the “basic” package, where the same LTK 210 service key is used for all channels within the basic package. As each subscriber may choose a different set of channels to view, multiple LTKs 210 may be delivered to the subscribers. For example, the channels in a basic service package may use the same long-term key LTK₀ 210. HBO™ channels for premium service may use LTK₁ 210. As such, the basic service subscribers will get LTK₀ 210 only and the premium service subscribers will get both LTK₀ 210 and LTK₁ 210. In this example, all of the long-term keys are updated during each billing period. In addition, only the subscribers who continue their service subscription get the updated LTKs 210. If the user stops his subscription, the device will not receive the LTK 210 for that subscription. Consequently, the device will be unable to derive the program key and access the content.

The LTK 210 may be used to derive a short-term key (STK) 230, which allows access to content for a short period. STK 230 is only valid within a short-term subscription interval to provide the short-term subscription service, such as a one-day subscription (this is a variant of a pay-by-time service). The STK 230 would change in every short-term subscription interval and is also unique for each content service. The service provider may define the minimum time interval for short-term subscription, for instance, from 3 to 24 hours. If the short-term subscriber purchases multiple time intervals, multiple STKs 230 will be delivered to the short-term subscriber. Each STK 230 is associated with a different Short-Term Label (STL) identifier 220 and derived by the LTK 210 and STL 220, according to an embodiment of the present invention. If the subscriber has selected short-term services on different channels, multiple STKs 230 may be delivered to that subscriber.

When a user receives an EMM containing the long term service key, the LTK can be identified by its service ID and a long term interval number. This number may start from 0 and increment by 1 for every long-term interval. The same service ID and number are delivered in the ECM corresponding to that service.

When a user receives an EMM containing an STK, the STK can be identified by the combination of the Service ID, and the long term interval number, and a short term interval number. This last number is an ID for each short-term interval within a long-term interval. It may start from 0 and increment by 1 for each short-term interval. Once a new long-term subscription period starts, it may be reset to zero and restart again. This short term number is also delivered in the ECM corresponding to that service.

When a user receives an EMM containing the program key, the program key can be identified by a channel number and a program number. The program number may start from 0 and is incremented by 1 for each program on a channel. When a new long term interval starts, it may be reset to zero and restart again. The channel number and program number are also delivered in the ECM corresponding to that service.

The Short-Term Label for a short-term subscription interval will be used in deriving the STK. It includes: (a) the service ID, (b) the long term interval number, and (c) the short-term interval number.

The STK derivation process uses the STL as input to an Advanced Encryption Standard (AES) encryption function, with the LTK as the encryption key. The resulting encrypted data is the STK. Users that receive the STK cannot reverse this process since they do not have the LTK. Therefore, by purchasing a short term service, a user cannot gain access to the higher level LTK and thus gain access to the entire service. Other one-way cryptographic functions may be used for deriving keys. Short-term subscribers receive the STK in their EMMs while long-term service subscribers have to derive the STK using the LTK they received in their EMM and the STL information received in the common ECM.

The STK 230 may be used to derive a program key (PK) 250. The PK 250 is a key used to decrypt the traffic keys for each program. The PK 250 changes for each program. The PK 250 is also unique for each program. The PK 250 may be derived from the STK 230 using the Program Label (PL) 240 received in the ECM. The PL 240 includes channel number and program number, and may include other program related information, such as copy protection information (e.g., one byte of CCI bits), blackout information, and control information. A short-term subscriber may derive a program key 250 using the STK 230 to get traffic keys (TKs) 260. Finally, the TK 260 is the key to decrypt the content 270. The TK 260 may change as often as once every second.

Users that purchased a single program will receive the PK in their EMMs while long-term and short-term service subscribers have to derive the PK using the STK they derived from LTK or received in their EMMs, respectively, and the PL information received in the common ECM.

The PK derivation process uses the PL, including optionally some other service or program related data, as an input to an AES encryption function, using the STK as the encryption key. The resulting encrypted data is the PK. Users that receive the PK cannot reverse this process since they do not have the STK. Therefore, by purchasing a single program (or event), a user cannot gain access to the higher level keys such as the STK or LTK and thus gain access to content he did not pay for.

Note that the TK in the ECM may not be encrypted by the PK directly. Instead, there may be an intermediate key called the access key 255 which decrypts the encrypted TK. In this case, the PL above includes only the program number and the channel number, and any other program related data, such as Copy Control Information (CCI), Program Control Information (PCI), Blackout Information (BI) (if present) and other data, is input into another AES based key derivation step as program data 245. This derivation is designed to provide CCI, PCI, and BI authentication for the ECM messages.

Program data 245 can in general be extended to include any data that needs to be authenticated for the content or program. As shown, by way of example, the program data 245 is used in conjunction with the program key 250 to derive the access key 255. Using the access key 255, the encrypted traffic key 257 may be decrypted to get the TK 260 and using the TK 260, the encrypted content 265 may be decrypted and a user may access the content 270.

Here, three levels of services have been described: long-term subscription, short-term subscription and PPV. The different levels of services are referred to as different business model levels or access types. Each business model level has different EMMs, which include Long-term subscription EMM, Short-term subscription EMM, and PPV EMM. The Long-term subscription EMM has to be delivered to all subscribers every month. By way of example, if the service provider has tens of millions of subscribers and each message has to be broadcast many times, vast amount of bandwidth will be required. The short-term subscription EMM is only delivered to the short-term service subscribers after they have purchased short-term subscription service. The short-term subscription EMM includes the STL 220 and the STK 230 for the time intervals that the purchaser is allowed to access the content. Here the STL 220 is used as an ID for the STK 230. The PPV EMM is only delivered to PPV users after they have purchased the PPV service. The PPV EMM includes the PL 240 and the PK 250 for the program the user purchased. Here the PL 240 is also used as an ID for the PK 250.

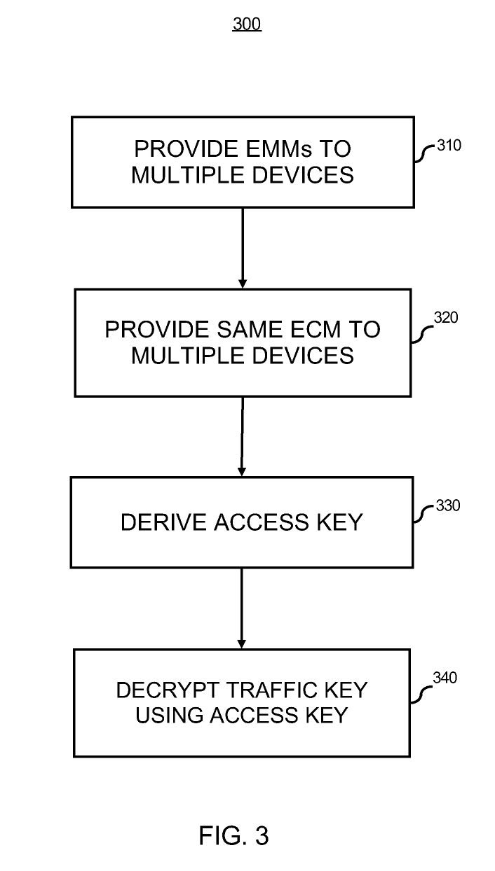

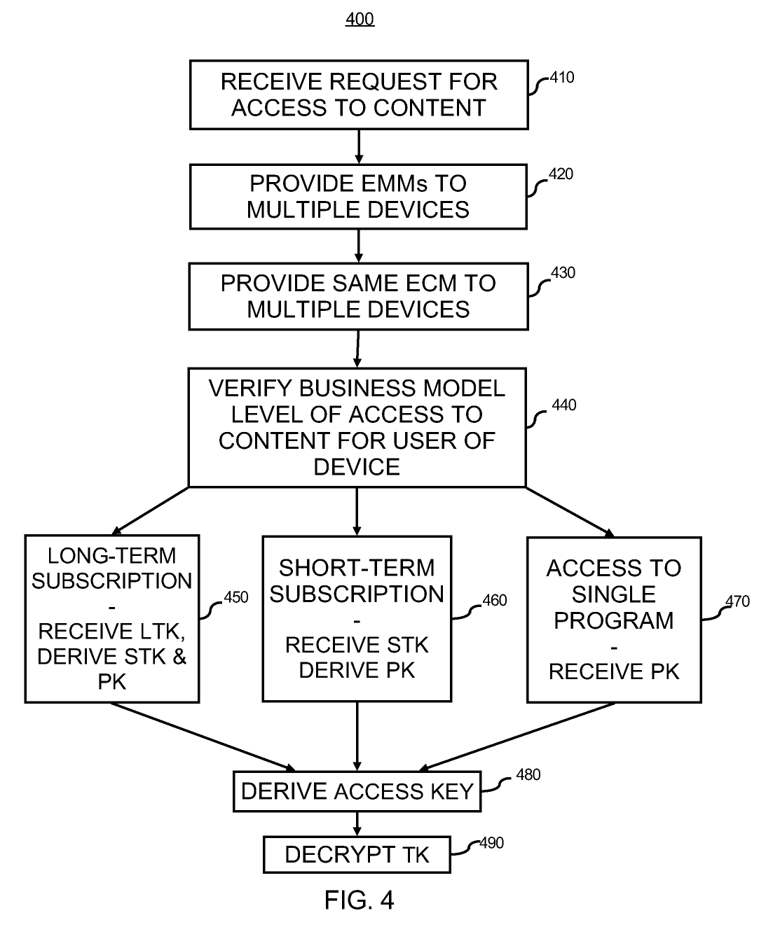

An embodiment of a method in which the system 100 may be employed for providing authorized access to content to a device will now be described with respect to the flow diagrams of the methods 300 and 400 depicted in FIGS. 3 and 4. It should be apparent to those of ordinary skill in the art that the methods 300 and 400, and for other methods described herein that other steps may be added or existing steps may be removed, modified or rearranged without departing from the scopes of the methods 300 and 400. Also, the methods are described with respect to the system 100 by way of example and not limitation, and the methods may be used in other systems.

FIG. 3 illustrates a flow diagram of a method 300 for providing authorized access to content to multiple devices using one ECM, according to an embodiment of the present invention. The method 300 is a process that provides authorized access to content for multiple devices using a same single ECM regardless of the fact that a user of each different device may have different business model levels of access to the content.

At step 310, EMMs are provided to the multiple devices. Here, one EMM may be provided to one device or one EMM may be provided to a group of devices. Each EMM includes at least one service key for one or more devices. The EMM is typically delivered uniquely to each of the multiple devices, with a service key corresponding to the purchased access model.

At step 320, an ECM is provided to the multiple devices. Although each of the multiple devices may have different business model levels of access to the content, the ECM provided to the multiple devices here is the same ECM for every device. The ECM includes an encrypted traffic key for decrypting content.

At step 330, each of the multiple devices derives one access key using the key delivered in the EMM and ECM according to the business model level of access to the content for a user of the device. For instance, a user who purchased a single event (or program) will receive the PK in his EMM and will have to derive from the ECM the access key. A subscriber to the entire service will receive an LTK in his EMM and will have to derive the STK first, then the PK and finally the access key.

At step 340, each of the multiple devices uses the key derived in step 330 to decrypt the traffic key(s) to access the content according to its own business model level of access to the content. In this step, the traffic keys are common to the multiple devices and each of the service keys is used for the appropriate business model level of access to the content.

Here, examples of the different business model levels of access to the content are a long-term subscription, a short-term subscription, and access to a single program. The short-term subscription has a shorter period of subscription than the long-term subscription, such as a weekly subscription or a daily subscription, whereas the long-term subscription has a monthly subscription or a yearly subscription. Examples of the service key are the long-term key 210, the short-term key 230, and the program key 250 in FIG. 2. In one example, a business model levels of access to content is access to a predetermined amount of content (e.g., predetermined number of channels or programs) and/or access to a predetermined amount of time of content (e.g., monthly subscription to a basic channel package or a premium channel package). Also, a fee or cost may be associated for each level (also referred to as access type) of the business model levels of access. For example, there are different fees for a monthly subscription, a weekly subscription, and a PPV. Each of the plurality of devices has one of a plurality of different business model levels of access to a specific service.

FIG. 4 illustrates a flowchart of a method 400 for providing authorized access to content to multiple devices with different access types using a one way key derivation process, according to an embodiment of the present invention.

At step 410, a request for access to the content is received at the service provider from multiple devices.

At step 420, an EMM is provided to each of the multiple devices. The EMM includes a service key for each device.

At step 430, an ECM is provided to the multiple devices. Each ECM includes a single encrypted traffic key for decrypting content. The ECM is typically provided continuously with the content, while the EMMs are delivered on request (step 410) or in advance.

At step 440, the device determines the business model level of access to the content for a user of the device as a long-term subscription, a short-term subscription, or access to a single program.

At step 450, if the business model level of access to the content for a user of the device is a long-term subscription, the device receives the LTK 210 from the EMM, and the device may derive the STK 230 and the PK 250 using the STL 220 and the PL 240 received from the ECM.

At step 460, if the business model level of access to the content for a user of the device is a short-term subscription, the device receives the STK 230 from the EMM, and the device may derive the PK 250 using the PL 240 received from the ECM.

Finally, at step 470, if the business model level of access to the content for a user of the device is access to a single program, the device receives the PK 250 from the EMM.

In step 480, each device derives the access key and, in step 490, decrypts the TK delivered in the ECM such that they all can decrypt the actual content. Here, each step of steps 450, 460, and 470 is operable as a one-way process or a one-way function and there is no return path available from lower level of business model service key to higher level of business model service key in the access key hierarchy.

It should be noted that the steps are repeated for each ECM for a particular time interval. For example, an ECM may be delivered for a traffic key that can be used to access a few seconds of content. Then, another ECM is delivered to access the next interval of time content, and so on. The method 400 can be used to derive the access key for each ECM for each time interval.

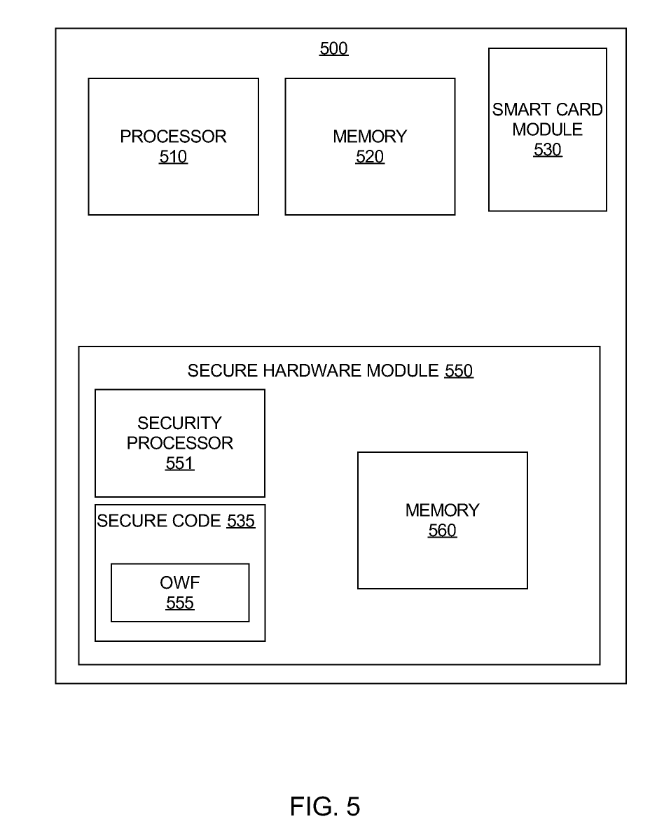

FIG. 5 shows a block diagram of a device 500 that may represent any one of the devices 140a-140n and 150a-150n shown in FIG. 1, according to an embodiment of the present invention. As described in FIG. 1 the device 500 may be a user device that wishes to have access to content or a service. The device 500 includes a processor 510, a memory 520, such as a computer readable medium, an optional smart card module 530, or an optional secure hardware module 550. The processor 510 is the component responsible for the majority of the device's functions, and it accesses the memory 520 for executable instructions to perform such functions. However, the processor 510 is not a secure device and susceptible to tampering. Consequently, the processor 510 usually handles only short-lived keys, such as the TK 260. The optional smart card module 530 is used to receive a smart card, on which is encoded a computer-readable data structure for the access key hierarchy 200, as mentioned earlier, for execution by the smart card module 530. Alternatively, the access key hierarchy algorithm 200 may be executed by the secure HW module 550. Alternatively, a combination of a smart card module 530 and a HW security module 550 could be used. There are SW obfuscation and transformation techniques available such that the algorithm 200 could be executed securely even on the main processor 510.

The secure hardware module 550 contains a security processor 551, a secure code 535, and a memory 560, such as a computer readable medium. In one embodiment, the secure hardware module 550 is a secure silicon hardware device, such as a tamper resistant silicon microchip. The security processor 551 is a secured processor that handles the processing functions for the secure hardware module 550, such as the execution of the one-way function (OWF) 555 used to produce the PK 250 or the STK 230 to decrypt the traffic key 260 as described earlier. The secure code 535 is a portion of the secure hardware module 550 that comprises various software code and applications that is executed by the security processor 551. Notably, one secure code 535 includes the OWF 555. As described earlier, it is possible to implement the access key hierarchy 200 as a computer-readable data structure that is implemented on a computer readable medium, such as the memory 560 in the secure hardware module 550. This ensures the security of the various encryption/decryption keys within the secure hardware module 550. In an alternative embodiment, a public/private key pair and associated digital certificate are stored on the smart card, and keys in the lower levels, such as service keys including a long-term key, a short-term key, a program key, and a traffic key are derived and stored in the memory 560.

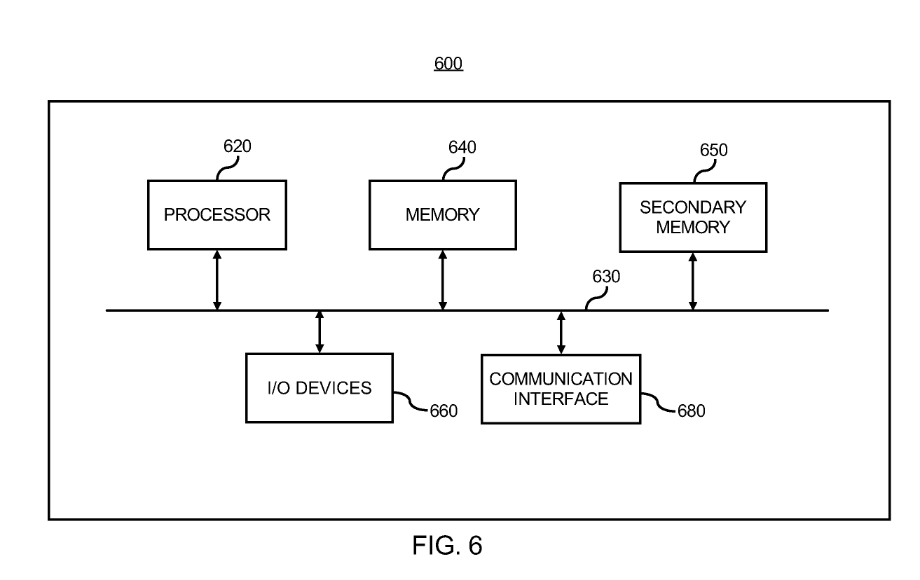

FIG. 6 shows the block diagram of a computer system 600 that may be used as a platform for a service provider configured to facilitate an authorized access to content for a device, such as a service subscriber device. The service subscriber device derives the access key 255 using a one-way function. As described in FIG. 1, the computer system 600 may be a server of the service provider 110. The computer system 600 may also be used to execute one or more computer programs performing the methods, steps and functions described herein. The computer programs are stored in computer storage mediums.

The computer system 600 includes a processor 620, providing an execution platform for executing software. The processor 620 is configured to provide an EMM including a service key to the plurality of devices. The processor 620 is further configured to provide a same ECM to the plurality of devices. The ECM comprises a single encrypted traffic key for decrypting content. The EMM generation software may run on a different computer system or processor than the ECM generation function. The computer system 600 may also include a secure Database for storing service, program and user related information including the LTKs and UKs. The computer system 600 may also include a HW security module to protect the ECM and EMM key derivation algorithms and to improve performance of the encryption or decryption functions.

Commands and data from the processor 620 are communicated over a communication bus 630. The computer system 600 also includes a main memory 640, such as a Random Access Memory (RAM), where software may reside during runtime, and a secondary memory 650. The secondary memory 650 may include, for example, a nonvolatile memory where a copy of software is stored. In one example, the secondary memory 650 also includes ROM (read only memory), EPROM (erasable, programmable ROM), EEPROM (electrically erasable, programmable ROM), and other data storage devices, include hard disks. The main memory 640 as well as the secondary memory 650 may store the EMM, the ECM, the access key, the traffic key, and the business model levels.

The computer system 600 includes I/O devices 660. The I/O devices 660 may include a display and/or user interfaces comprising one or more I/O devices, such as a keyboard, a mouse, a stylus, speaker, and the like. A communication interface 680 is provided for communicating with other components. The communication interface 680 may be a wireless interface. The communication interface 680 may be a network interface. The communication interface 680 is configured to receive requests for EMMs and to send the EMMs and the ECMs.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims and their equivalents in which all terms are mean in their broadest reasonable sense unless otherwise indicated.

What is claimed is:

1. A method for providing authorized access to content for a plurality of devices, the method comprising:
providing multiple entitlement management messages (EMMs), each EMM including a service key, to the plurality of devices; and
providing a same entitlement control message (ECM) to the plurality of devices, wherein the same ECM comprises an encrypted traffic key for decrypting content, and each of the plurality of devices derives an access key from the service key according to a business model level of access to the content for a user of each of the plurality of devices, and uses the access key to decrypt the traffic key to access the content according to the business model level of access to the content for the each of the plurality of devices.

2. The method of claim 1, wherein each of the plurality of devices has one of a plurality of different business model levels of access to a specific service.

3. The method of claim 2, wherein the one of a plurality of different business model levels of access to the content is selected from a group consisting of a long-term subscription, a short-term subscription, and access to a single program, wherein the short-term subscription has a shorter period of subscription than the long-term subscription.

4. The method of claim 2, wherein the access key is derived from a long-term key, a short-term key, or a program key.

5. The method of claim 4, wherein the method further comprises:
deriving the short-term key from the long term key using a short term label and a cryptographic function.

6. The method of claim 5, wherein the method further comprises:
deriving the program key from the short-term key using a program label and a cryptographic function.

7. The method of claim 4, wherein the long term key changes in a first predetermined time interval and the long term key is unique for the specific service.

8. The method of claim 7, wherein the short-term key changes in a second predetermined time interval that is shorter than the first predetermined time interval and the short-term key is unique for the specific service.

9. The method of claim 8, wherein the program key changes for each program and the program key is unique for each program interval of the specific service.

10. The method of claim 4, wherein the service key comprises the long-term key, the short-term key, or the program key, and the service key is used for different business model levels of access to the content for the each of the plurality of devices.

11. The method of claim 1, wherein each of the plurality of devices uses program data and a cryptographic function to derive the access key from the program key, and the program data is authenticated for the specific service if the access key is usable to access content for the specific service.

12. The method of claim 1, wherein each of the plurality of devices decrypts the traffic key using the access key.

13. The method of claim 12, wherein each of the plurality of devices decrypts the content using the traffic key.

14. The method of claim 1, wherein the same ECM is provided to the plurality of devices for a single content channel time interval.

15. A computer system configured to facilitate authorized access to content for a plurality of devices, the computer system comprising:
a processor configured to provide multiple entitlement management messages (EMMs), each EMM including a service key, to the plurality of devices;
wherein the processor is further configured to provide a same entitlement control message (ECM) to the plurality of devices, and the same ECM comprises an encrypted traffic key for decrypting content, and
each of the plurality of devices derives an access key from the service key according to a business model level of access to the content for a user of the each of the plurality of devices, and uses the access key to decrypt the traffic key to access the content according to the business model level of access to the content for the each of the plurality of devices; and
an interface configured to transmit the EMMs and the ECM to the plurality of devices.

16. The computer system of claim 15, wherein the business model level of access to the content is selected from a group consisting of a first time interval subscription, a second time interval subscription, and access to a single program, wherein the second time interval is shorter than the first time interval.

17. The computer system of claim 15, wherein each of the plurality of devices derives the access key using a one-way function and the one-way function derives a short-term key or a program key in a one-way direction.

18. A device configured to access content from a service provider, the device comprising:
a processor configured to receive an entitlement management message (EMM) including a service key,
wherein the processor is further configured to receive an entitlement control message (ECM) from the service provider, and the ECM comprises an encrypted traffic key for decrypting content, and the device derives an access key from the service key according to a business model level of access to the content for a user of the device, and uses the access key to decrypt the traffic key to access the content according to the business model level of access to the content for the device,
wherein the same ECM is sent to multiple other devices and each of the other devices derives an access key from the service key according to a business model level of access to the content for a user of the other device;
an interface configured to receive the EMM and the ECM; and
a data storage storing information from the EMM and the ECM.

19. The device of claim 18, wherein the business model level of access for the device is one of a plurality of different business model levels of access to a specific service, and the one of a plurality of different business model levels of access to a specific service is selected from a group consisting of a first time interval subscription, a second time interval subscription, and access to a single program, wherein the second time interval is shorter than the first time interval.

20. The device of claim 18, wherein the service key is selected from a group consisting of a long-term key, a short-term key, and a program key, and the processor is further configured to derive the short-term key from the long-term key, derive the program key from the short-term key, derive the access key from the program key, and decrypt the traffic key using the access key.
